(19) United States
(12) Patent Application Publication
(10) Pub. No.: US 2007/0239688 A1
(43) Pub. Date: Oct. 11, 2007

(54) System and method for altering search result sequence based on user preferences

(76) Inventors: David K. Clark, Cedar Park, TX (US); David Salinas, Pflugerville, TX (US); Theodore J. L. Shrader, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/402,983

(22) Filed: Apr. 11, 2006

(51) Int. Cl. G06F 17/30

(52) U.S. Cl. 707/3

(57) ABSTRACT

A system and method for receiving search criteria from a client; determining if the client has specified a set of user preferences for defining a search result presentation order when returning a plurality of search results, in response to uniquely identifying the client; and presenting the plurality of search results in the search result presentation order as defined by the user preferences, in response to determining the client has specified a set of user preferences.

### BACKGROUND OF THE INVENTION

1. Technical Field

The present invention relates in general to the field of data processing systems. More particularly, the present invention relates to the field of performing searches utilizing data processing systems. Still more particularly, the present invention relates to a system and method for altering search results sequence based on user preferences.

2. Description of the Related Art

Early computers were stand-alone units, which accessed and processed only local databases using local computer programs. Today, however, modem computers are often networked, thus providing client computers on a network access to a variety of resources, including data, computer programs, hardware devices (including storage drives and printers), etc. This resource availability is especially prevalent with the advent of the Internet, World Wide Web, private intranets and extranets, etc., which provide access to web pages, databases, programs, and similar resources.

Often, when a client queries a search engine for search results, the search engine presents the search results in an order that is undesirable or inconvenient for the client. Therefore, there is a need for a system and method to address the aforementioned limitation of the prior art.

### SUMMARY OF THE INVENTION

The present invention includes system, method, and computer-usable medium for receiving search criteria from a client; determining if the client has specified a set of user preferences for defining a search result presentation order when returning a plurality of search results, in response to uniquely identifying the client; and presenting the plurality of search results in the search result presentation order as defined by the user preferences, in response to determining the client has specified a set of user preferences.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram depicting an exemplary network in which a preferred embodiment of the present invention may be implemented;

FIG. 2 is block diagram illustrating an exemplary data processing system in which a preferred embodiment of the present invention may be implemented;

FIG. 3 is a block diagram depicting exemplary contents of a system memory in which a preferred embodiment of the present invention may be implemented; and

FIG. 4 is a high-level logical flowchart illustrating an exemplary method for altering search results sequence based on user preferences.

### DETAILED DESCRIPTION OF A PREFERRED EMBODIMENT

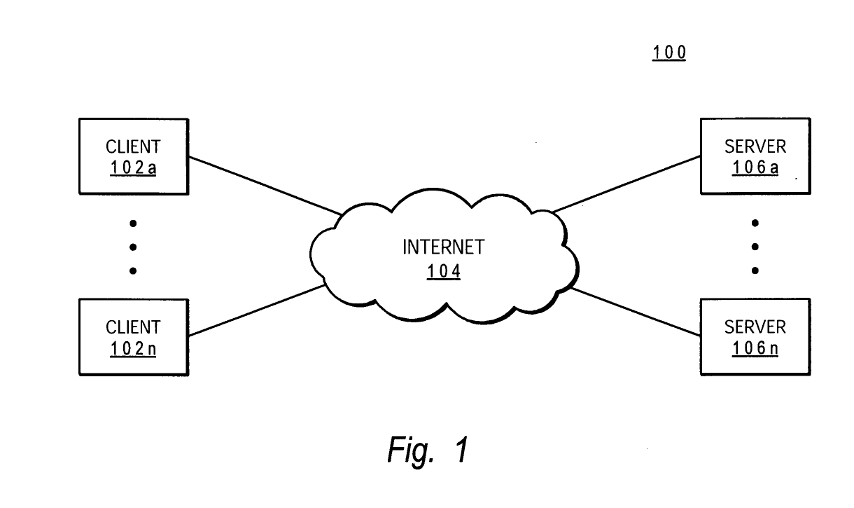

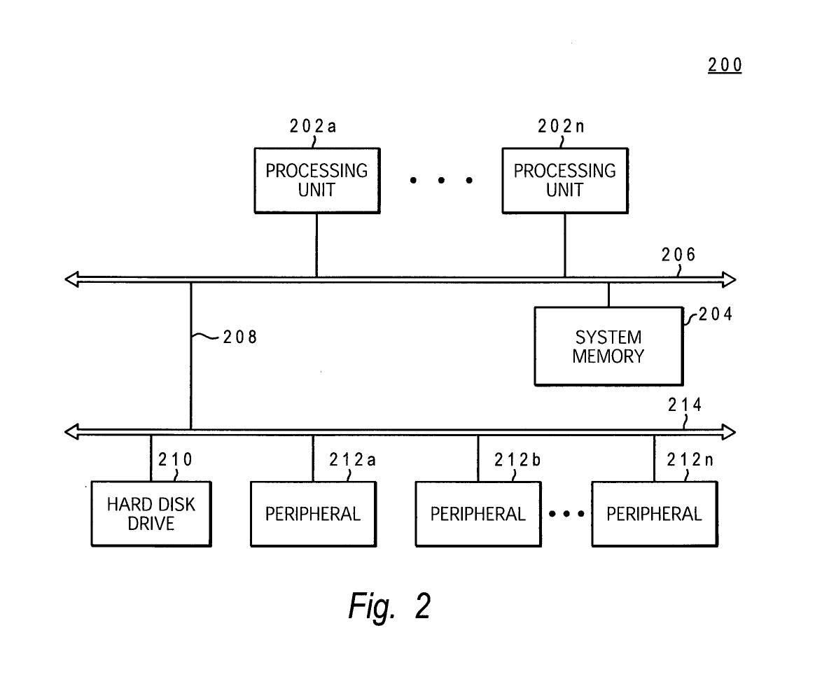

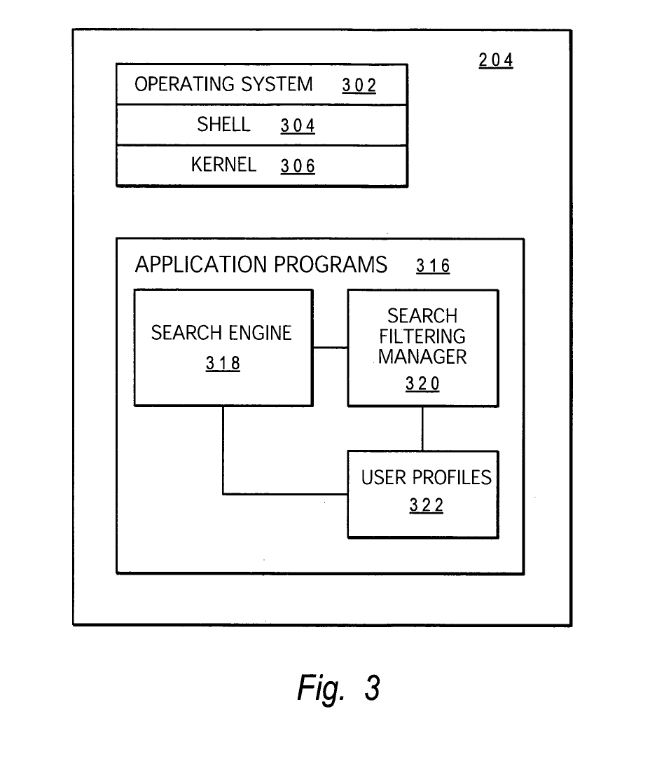

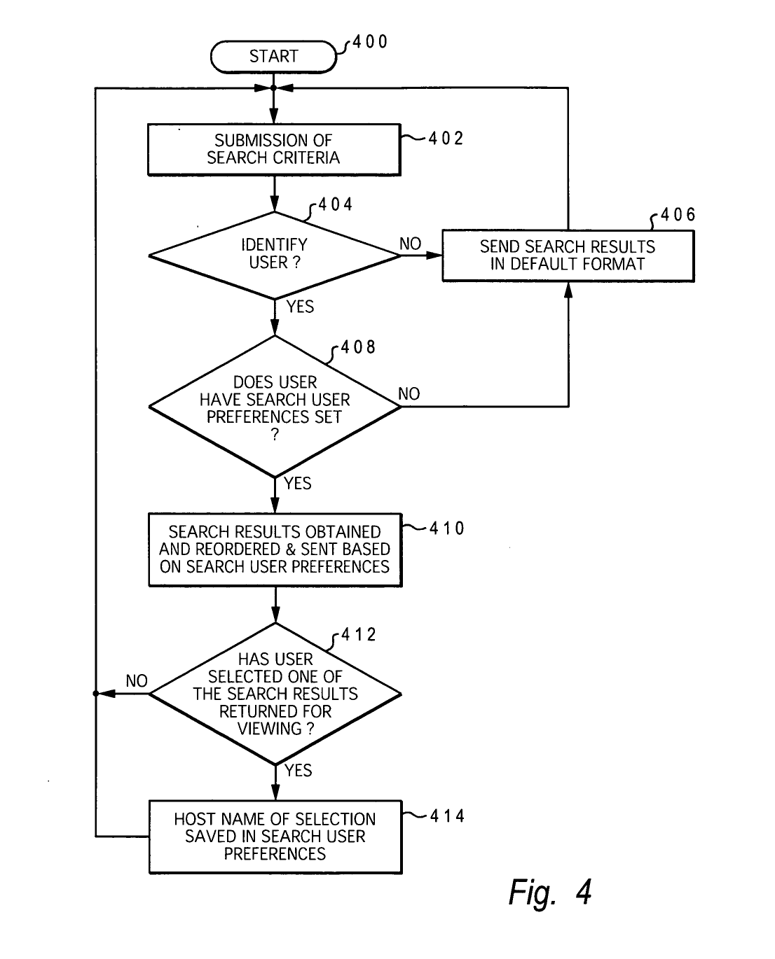

With reference now to the figures, and in particular, with reference now to FIG. 1, there is illustrated an exemplary network 100 in which a preferred embodiment of the present invention may be implemented. As illustrated, network 100 includes a collection of clients 102a-n that are coupled to servers 106a-n via Internet 104. Those with skill in the art will appreciate that clients 102a-n and servers 106a-n may be implemented by any type of computer system, such as data processing system 200, as depicted in FIG. 2. Also, while Internet 104 is utilized to couple clients 102a-n to servers 106a-n, those with skill in the art will appreciate that any type of network connection such as Ethernet, wireless (e.g., IEEE 802.11x), or any type of local area network (LAN) or wide area network (WAN) may be utilized. In a preferred embodiment of the present invention, clients 102a-n connect to servers 106a-n to send search requests to a search engine 318 and receive search results presented an alternate presentation order by a search filtering manager 320, both discussed herein in more detail in conjunction with FIGS. 3 and 4.

Those skilled in the art will appreciate that network 100 can include many additional components not specifically illustrated in FIG. 1. Because such additional components are not necessary for an understanding of the present invention, they are not illustrated in FIG. 1 or discussed further herein.

Referring to FIG. 2, there is depicted a block diagram of an exemplary data processing system in which a preferred embodiment of the present invention may be implemented. Data processing system 200 may be utilized to implement clients 102a-n and servers 106a-n. As depicted, exemplary data processing system 200 includes processing unit(s) 202, shown as processing units 202a and 202n in FIG. 2, which are coupled to system memory 204 via system bus 206. Preferably, system memory 204 may be implemented as a collection of dynamic random access memory (DRAM) modules. Typically, system memory 204 includes data and instructions for running a collection of applications. Mezzanine bus 208 acts as an intermediary between system bus 206 and peripheral bus 214. Those with skill in this art will appreciate that peripheral bus 214 may be implemented as a peripheral component interconnect (PCI), accelerated graphics port (AGP), or any other peripheral bus. Coupled to peripheral bus 214 is hard disk drive 210, which is utilized by data processing system 200 as a mass storage device. Also coupled to peripheral bus 214 is a collection of peripherals 212a-n.

FIG. 3 is a block diagram illustrating exemplary contents of system memory 204 for servers 106a-n according to a preferred embodiment of the present invention. As illustrated, system memory 204 includes operating system 302, which further includes shell 304 for providing transparent user access to resources such as application programs 316. Generally, shell 304 is a program that provides an interpreter and an interface between the user and the operating system. More specifically, shell 304 executes commands that are entered into a command line user interface or a file. Thus, shell 304 (as it is called in UNIX®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 306) for processing. Note that while shell 304 is a text-based, line-oriented user interface, the present invention will support other user interface modes, such as graphical, voice, gestural, etc. equally well.

As illustrated, operating system 302 also includes kernel 306, which includes lower levels of functionality for operating system 302, including providing essential services required by other parts of operating system 302 and application programs 316, including memory management, process and task management, disk management, and mouse and keyboard management. Application programs 316 can include a search engine 318, search filtering manager 320 (discussed herein in more detail), user profiles 322 , word processors, spreadsheets, and other application programs. According to a preferred embodiment of the present invention, search engine 318 and search filtering manager 320 receive search requests from clients 102a-n and present search results in an alternate presentation order. The alternate presentation order utilized to present the search results are determined via user-selected preferences stored in user profiles 322. If a connected client does not have a corresponding user profile stored in user profiles 322, the search results are presented in a default order (e.g., biasing the search results by listing “preferred” results, such as results related to commercial providers of goods and/or services).

FIG. 4 is a high-level logical flowchart diagram depicting an exemplary method for altering search results sequence based on user preferences according to a preferred embodiment of the present invention. The process begins at step 400 and proceeds to step 402, which illustrates a client (e.g., client 102a) submitting search criteria to servers 106a-n, which implement search engine 318, as illustrated in FIG. 3. Servers 106a-n then attempt to identify the client that sent the search criteria, as illustrated in step 404. In a preferred embodiment of the present invention, servers 106a-n may identify the sending client by examining “cookies” stored in the system memory of client 102a. “Cookies” are small packets of information stored on client computers by servers in order to uniquely identify the client computers across multiple sessions. Those with skill in the art will appreciate that the present invention is not limited to utilizing cookies to uniquely identify the client, but any type of identify may be utilized.

Servers 106a-n cannot uniquely identify client 102a, the process continues to step 406, which illustrates servers 106a-n sending the requested search results utilizing a default format (e.g., listing the search results with “preferred” results, such as results related to commercial providers of goods and/or services, near the beginning of the list). The process returns to step 402 and proceeds in an iterative fashion.

If servers 106a-n successfully identify client 102a, the process continues to step 408, which illustrates servers 106a-n searching user profiles 322 to determine if client 102a has specified a set of user preferences for returning search results. Those with skill in the art will appreciate that the set of user preferences are not required to be stored in user profiles 322, but may be specified in the identifier (e.g., cookie) utilized to uniquely identify client 102a. If client 102a has not specified a set of user preferences, the process continues to step 406, which depicts servers 106a-n sending the search results utilizing a default format. The process returns to step 402 and proceeds in an iterative fashion.

Returning to step 408, if servers 106a-n determine that client 102a has previously specified a set of user preferences regarding search results, the process continues to step 410, which illustrates search filtering manager 320 ordering the search results based on the user preferences and sending the search results to client 102a. In a preferred embodiment of the present invention, some user preferences may include, but are not limited to, client 102a's previously-visited search engine results, a “favorite hostname” either explicitly (via bookmarked favorites in a browser or an set of links explicitly specified by client 102a to redefine search result presentation order) or implicitly specified by client 102a in a prior session (via a selection of a search result in a prior session).

The process continues to step 412, which illustrates server 106a-n determining if client 102a has selected one of the returned search results for viewing. If client 102a has not selected any of the search results, the process returns to step 402 and proceeds in an iterative fashion. If, however, client 102a has selected at least one of the search results for viewing, the hostname of the computer hosting the selected search result is added to the user preferences of preferred hostnames, as depicted in step 414. The process returns to step 402 and proceeds in an iterative fashion.

As discussed, the present invention includes a system, method, and computer-usable medium for receiving search criteria from a client; determining if the client has specified a set of user preferences for defining a search result presentation order when returning a plurality of search results, in response to uniquely identifying the client; and presenting the plurality of search results in the search result presentation order as defined by the user preferences, in response to determining the client has specified a set of user preferences.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD-ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A method comprising:
receiving search criteria from a client;
in response to uniquely identifying said client, determining if said client has specified a set of user preferences for defining a search result presentation order when returning a plurality of search results; and
in response to determining said client has specified a set of user preferences, presenting said plurality of search results in said search result presentation order as defined by said user preferences.

2. The method according to claim 1, wherein said set of user preferences further includes at least one search result among said plurality of search results previously-selected by said client.

3. The method according to claim 1, wherein said set of user preferences further includes a plurality of links explicitly specified by said client.

4. The method according to claim 1, wherein said set of user preferences further includes a plurality of bookmarked favorites in a browser.

5. The method according to claim 1, further comprising:
in response to determining said client has selected a first search result among said plurality of search results, modifying said set of user preferences to influence a display of search results by including said first search result in said set of user preferences.

6. A system comprising:
a processor;
a data bus coupled to said processor;
a computer-usable medium embodying computer program code, said computer-usable medium being coupled to said data bus, said computer program code comprising instructions executable by said processor and configured for:
receiving search criteria from a client;
in response to uniquely identifying said client, determining if said client has specified a set of user preferences for defining a search result presentation order when returning a plurality of search results; and
in response to determining said client has specified a set of user preferences, presenting said plurality of search results in said search result presentation order as defined by said user preferences.

7. The system according to claim 6, wherein said set of user preferences further includes at least one search result among said plurality of search results previously-selected by said client.

8. The system according to claim 6, wherein said set of user preferences further includes a plurality of links explicitly specified by said client.

9. The system according to claim 6, wherein said set of user preferences further includes a plurality of links explicitly specified by said client.

10. The system according to claim 6, wherein said instructions are further configured for:
in response to determining said client has selected a first search result among said plurality of search results, modifying said set of user preferences to influence a display of search results by including said first search result in said set of user preferences.

11. A computer-usable medium embodying computer program code, said computer program code comprising computer-executable instructions configured for:
receiving search criteria from a client;
in response to uniquely identifying said client, determining if said client has specified a set of user preferences for defining a search result presentation order when returning a plurality of search results; and
in response to determining said client has specified a set of user preferences, presenting said plurality of search results in said search result presentation order as defined by said user preferences.

12. The computer-usable medium according to claim 11, wherein said set of user preferences further includes at least one search result among said plurality of search results previously-selected by said client.

13. The computer-usable medium according to claim 11, wherein said set of user preferences further includes a plurality of links explicitly specified by said client.

14. The computer-usable medium according to claim 11, wherein said set of user preferences further includes a plurality of bookmarked favorites in a browser.

15. The computer-usable medium according to claim 11, wherein said embodied computer program code further comprises computer-executable instructions configured for:
in response to determining said client has selected a first search result among said plurality of search results, modifying said set of user preferences to influence a display of search results by including said first search result in said set of user preferences.
